(19) United States
(12) Patent Application Publication
(10) Pub. No.: US 2017/0287019 A1
(43) Pub. Date: Oct. 5, 2017

(54) MOBILE, CROWD SOURCED VEHICLE APPRAISAL APPLICATION

(71) Applicant: Dealer Market Exchange PR LLC, GUAYNABO, PR (US)

(72) Inventors: Wesley L. REID, West Orange, NJ (US); Jason L. BENNICK, Guaynabo, PR (US)

(21) Appl. No.: 15/476,581

(22) Filed: Mar. 31, 2017

Related U.S. Application Data
(60) Provisional application No. 62/317,287, filed on Apr. 1, 2016.

(51) Int. Cl. G06Q 30/02

(52) U.S. Cl. CPC G06Q 30/0278

(57) ABSTRACT

The system provides a way to quickly rate and grade a vehicle using a guided template on a smartphone, tablet, or other mobile device. Once graded, a vehicle can be viewed against available market book and online resale values that are geo-specific, with final rating information based on the inspection pushed into a cloud of connected users in crowdsourced manner that allows users to respond with non-binding bids to purchase the vehicle, creating both a dynamic and real time valuation of that vehicle for trade in purposes, as well as access to a wholesale market for possible immediate resale, dealer trade, or other transfer and disposition of the vehicle.

This patent application claims priority to U.S. Provisional Patent App. No. 62/317,287 filed on Apr. 1, 2016, which is incorporated by reference herein in its entirety.

### BACKGROUND OF THE SYSTEM

In the automotive business, a potential purchaser of a vehicle typically already owns a vehicle (used). The purchaser typically wants to “trade in” their existing (used) vehicle at an assumed value that will be used to offset the purchase price of the (newly) purchased vehicle. In the prior art, there are a number of methods for determining the value of a used vehicle for purposes of a trade in. One such prior art system is the use of the Kelly Blue Book (KBB). KBB is implemented as a web based service. A user will input information about a vehicle, namely year, make, model, mileage, options, and the like, along with an assumed vehicle condition and quality grade (e.g. is the condition excellent, very good, good, or fair), not necessarily determined by an individual qualified to make such determination. At that point, KBB calculates a value range for the vehicle based on whether it is for trade-in or sale to a private party. The trade-in value is usually significantly lower than the value if selling to a private party.

Another current system for evaluating the value of a vehicle is to search identical or similar vehicles for sale on an interne site such as AutoTrader, Yahoo cars, TrueCar.com and the like. Such a search will provide an estimate of the private party price of a (used) vehicle.

A disadvantage of such prior art systems is that the data is generalized, meaning it is based on variables of comparatives and conditions and as such can be unreliable. Most existing private vehicle owners have been known to over-estimate the condition of their vehicle so that online advertisements result in inflated prices. KBB is based on past data that may not be accurate for a current season, geographical area, or demand for a particular vehicle.

Another disadvantage is that the current systems do not provide a feel for the actual market faced by an automobile dealer. If a dealer accepts a used vehicle as trade in, the dealer can either place the used vehicle on its lot and attempt to sell it at retail, or the dealer can sell the vehicle on the wholesale market to another dealer that has a desire for that vehicle or similar vehicles, or the dealer can sell the vehicle at a vehicle auction. Current valuation systems do not include simple, affordable or consistently accurate access to knowledge about the wholesale and auction market for establishing value.

Another disadvantage of current systems is that they are static, and don't provided the real time change in demand and supply that can impact the value of the vehicle.

A dealer may also decide to sell the vehicle at a periodic auction after acquiring the vehicle. A disadvantage of this is that there is some time period after obtaining the vehicle before the auction, requiring the dealer to hold the vehicle in inventory until disposition. Another disadvantage is that the auction price may be less than the appraised value or amount provided as trade-in value for the vehicle. Even if the auction price exceeds the trade-in value, the amount of profit may be less than expected.

A dealer often will sell used vehicles obtained as trade-in on the dealer lot, even if they are from a different manufacturer. This is an expensive procedure that may require advertising expenses and long delays in selling the vehicle.

### SUMMARY

The system provides a way to quickly rate and grade a vehicle using a guided template on a smartphone, tablet, or other mobile device. Once graded, a vehicle can be viewed against available market book and online resale values that are geo-specific, with final rating information based on the inspection pushed into a cloud of connected users in crowdsourced manner that allows users to respond with non-binding bids to purchase the vehicle, creating both a dynamic and real time valuation of that vehicle for trade in purposes, as well as access to a wholesale market for possible immediate resale, dealer trade, or other transfer and disposition of the vehicle.

### BRIEF DESCRIPTION OF THE DRAWINGS

FIG. 1 illustrates an example display after a VIN has been scanned.

FIG. 2 illustrates an example display of a vehicle condition grade interface in an embodiment of the system.

FIG. 3 illustrates an example vehicle condition grade summary as a completed “appraisal” in an embodiment of the system.

FIG. 4 illustrates an example display to a network dealership when requesting a bid on the appraised vehicle.

FIG. 5 illustrates an example interface for entering a bid for the appraised vehicle in an embodiment of the system.

FIG. 6 is a flow diagram illustrating the operation of the vehicle appraisal system in an embodiment of the system.

FIG. 7 is a flow diagram illustrating the operation of a crowd sourced bidding on the appraisal in an embodiment of the system.

FIG. 8 is an embodiment of the system in use.

FIG. 9 is a block diagram of an embodiment of the system server.

FIG. 10 is a flow diagram illustrating the creation of an Agent in an embodiment of the system.

FIG. 11 is a flow diagram illustrating an embodiment of Agent matching in an embodiment of the system.

FIG. 12 is an example computer embodiment.

### DETAILED DESCRIPTION OF THE SYSTEM

When a vehicle is offered for trade in or for some other reason at a dealership, the dealer has a desire to properly valuate the vehicle as quickly as possible. First, the dealer desires to determine the condition and value of the vehicle so that a proper exchange (trade) value can be determined and offered to the vehicle owner. If the dealer valuation is too high, the dealer (seller) will lose money on the transaction. If the dealer valuation is too low, the customer (buyer) may not purchase a vehicle from the dealer, causing the dealer to miss out on a possible sale. Current valuation systems do not necessarily reflect the dynamic supply and demand conditions that exist in the dealer-to-dealer wholesale market. The present system allows a dealer to obtain accurate valuation at a real time point in the market by buyers who are specifically interested in the purchase of that given vehicle, so that the best possible valuation can be applied to the vehicle to maximize business opportunities.

The system utilizes a quick and reliable vehicle condition grading system without the need for a detailed certified vehicle inspection that can be easily executed and shared with others through a cloud environment of data in a dealer wholesale market. The grading system is shared and adopted by other dealers in the nationwide wholesale market so that a generally accepted method of normalized description and understanding of the vehicle can be quickly generated and shared. Another component of the system is a shared wholesale market network that allows dealers to indicate an interest in specific types of vehicle. Another component of the market is a method of broadcasting through a cloud technology environment the availability of a vehicle only to those dealers who have expressed an interest in that type of vehicle. Another component of the system is the crowd sourcing of those interested dealers to establish an instantaneous and real time valuation of the vehicle through enabling responses through bids to purchase that vehicle. The dealer can then use that information to establish an accurate valuation of the vehicle for trade in purposes.

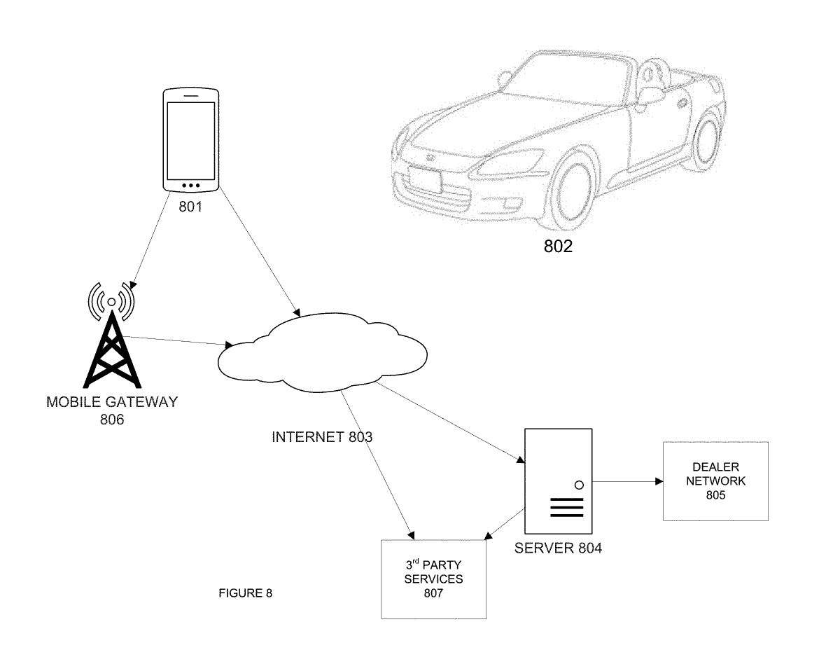

The system uses an application that may be implemented on any mobile device, such as a smartphone, tablet, pad, or other suitable mobile processing device. The system provides a guided method of entering objective and subjective information about the vehicle. In one embodiment, the system begins with objective data. One embodiment of use of the system is illustrated in FIG. 8. A mobile device 801 is used to obtain, receive, and enter information about vehicle 802. The mobile device 801 communicates over one or more wireless networks, such as mobile gateway 806 or network 803 (e.g. the Internet). The mobile device 801 uses the wireless networks to communicate with system server 804. System server 804 is in communication with 3^{rd} party services 807 and Dealer Network 805.

A user can use the mobile device 801 to scan or enter identification information about the vehicle 802, take images of the vehicle, and transmit the information to the system server 804 for instant appraisal/estimate information as well as other applications. The mobile device can receive vehicle related information from one or more 3^{rd} party services 807 directly or via the system server 804. The system server 804 is also in communication with Dealer Network 805. Dealer Network 805 comprises one or more vehicle dealers that participate in the system, and are willing to receive and send communication related to vehicles to other dealers on the network and also to mobile device such as mobile device 801.

Appraisal

One of the processes provided by the system is an ability to quickly obtain information about the vehicle 802 using the mobile device 801 in order to obtain appraisal, estimate, and valuation information about the vehicle. This can be for the purposes of trade-in, purchase, or sale of the vehicle.

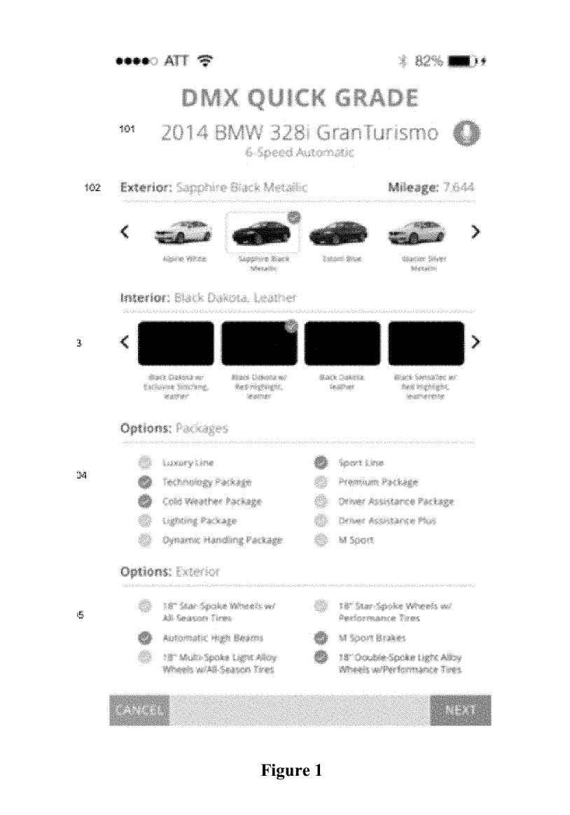

FIG. 6 is a flow diagram illustrating the operation of the appraisal system in one embodiment in connection with FIGS. 1-5. At step 601 the system is initiated and the Vehicle Identification Number (VIN) of the vehicle under consideration is acquired. This may be accomplished a number of ways. In one embodiment, the system can capture an image of the VIN to transmit to a VIN database to acquire vehicle information. In other cases, a scanner or QR code reader may be utilized to acquire the VIN. In another embodiment, the VIN may be entered manually into the mobile device for use in obtaining the related information about the vehicle.

After acquisition, the VIN may then be provided to a database so that information about the vehicle can be obtained, such as make, model, year, trim package, and the like. There are a number of databases that provide vehicle information based on the VIN. The system can take advantage of some or all of these databases to populate necessary fields associated with the vehicle. The vehicle information is then returned to the mobile device.

When information from the database is returned, the user of the system can do a visual verification at step 602 to ensure that the make, model and other vehicle information appears to be correct. If the information is not correct, the user returns to step 601 to try again, or may select from information provided in the system to elect what is correct. If the information appears to be correct, the system proceeds to step 603.

In some cases, the VIN can be tied to a database that includes information and data of all options (packages) that were on the vehicle at the date of purchase. These options and other information about packages associated with the vehicle will be auto-populated and presented to the user in an interface. An example of an interface after the VIN scan operation is illustrated in FIG. 1. The interface includes a number of regions that are consistent for each appraisal operation and is normalized for each manufacturer, make, and model so that a user can easily use the system regardless of the type of vehicle.

Region 101 includes the year, make, and model of the vehicle. Region 102 includes exterior color information and mileage information (in one embodiment the mileage is typically entered manually via a numeric keypad interface that appears when the user taps on the mileage field). From a database, the system may present all the factory exterior colors that were available on that vehicle. The user can scroll through the choices until selecting the one that matches the vehicle exterior color. In other instances, the exterior color will be pre-selected from the VIN and the user can verify that the color is correct. If the VIN indicates one color, and the car is actually another color, that can indicate repainting, repair, and the like. Similarly, the user can select the interior color at region 103, or it can be preselected and pre-populated as well.

Region 104 shows the possible and preselected option packages for the vehicle. Region 105 shows exterior options for the vehicle, with some auto-populated based on the VIN. At step 603 of FIG. 6, the user is prompted to review and add or remove options as appropriate, based on the visual inspection of the vehicle. The user can visually confirm the packages and options while inspecting the vehicle and add or remove options as appropriate.

At step 604, the system then directs the user to take pictures of the vehicle from certain perspectives, directions, and distances. These pictures will be same for nearly every vehicle and provide a complete view of the vehicle that can be easily used by others to confirm the subjective and objective data associated with the vehicle. By instructing the user how and from what perspective to take the pictures, the images themselves are normalized for use by the system and by others using the system.

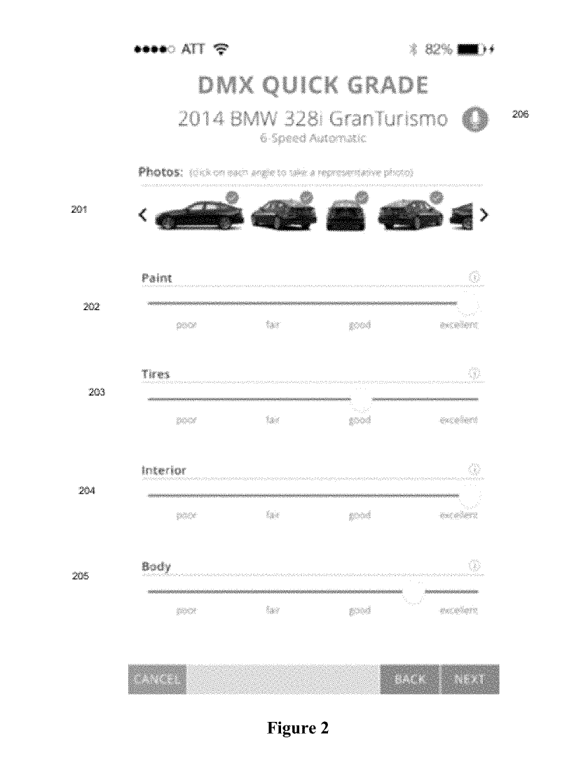

Referring briefly to FIG. 2, region 201 illustrates the desired views to be photographed of the vehicle. The views can include side view (each side) front and back view, three quarter view from each corner, and the like. As each view is photographed, the user confirms by checking the corresponding view icon in region 201 until all views have been taken.

At step 605 the appraisal system prompts the user for subjective grades of a plurality of items, including paint 202, tires 203, interior 204, and body 205. As shown in FIG. 2, the subjective ratings can be numeric, touch based, or some other suitable method of entering an appropriate rating. In some instances, examples of other vehicles for each tier of rating for each item are provided so that even more novice users can obtain meaningful ratings. This can be accessed in one embodiment by clicking the “i” in a circle icon near each rating. Selecting the “i” information also can explain the rating system to provide consistency among users of the system.

Once the grading is complete, the user may be invited at step 606 to append an audio note with the grading to vocally describe any aspects of the vehicle or its condition that will help others provide a meaningful bid and subsequent valuation of the vehicle. This may be accomplished by tapping the microphone icon 206.

At step 607, the system provides a first estimate and appraisal of the vehicle. This may be based on various databases, such as recent sales in the area, ads for sales of similar vehicles, and estimates of vehicles provided by 3^{rd} party services.

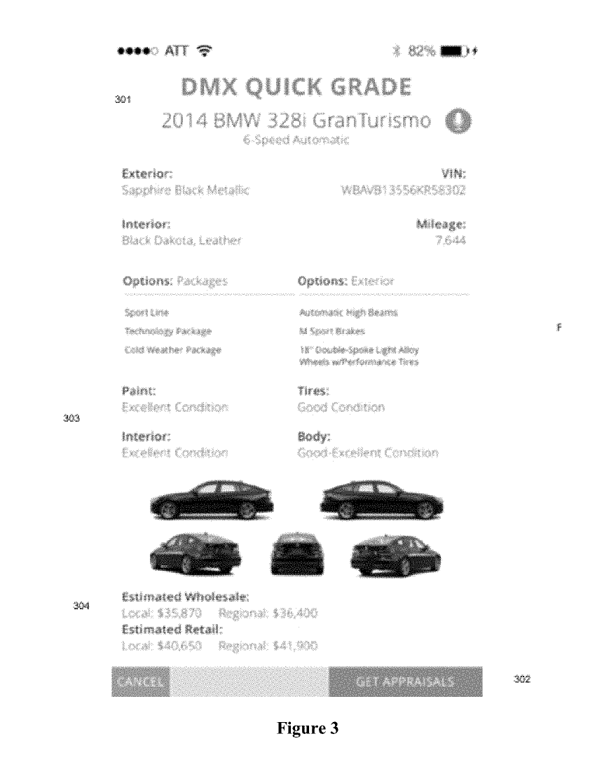

An example of a completed first estimate and appraisal is illustrated in FIG. 3. The vehicle objective information is shown in region 301 and subjective ratings are shown in region 303. The system may also present a feature of including a current market or typical valuation of the vehicle in region 304 based on data integration that is fed in real-time into the system, resulting from a third party market vehicle valuation service, such as KBB, or any other such service. The current market estimate can be a range of values and can also reflect local and regional prices for the vehicle.

At this point the user may end the process and use the first estimate or appraisal to assign value to the vehicle. If this process is occurring at a dealer lot, the dealer may offer a trade-in value for the vehicle based on the first appraisal. In one embodiment, the user may take advantage of the crowd sourced aspect of the system to determine a second estimate or appraisal of the vehicle, and even arrange for a possible sale. Depending on the interest in the vehicle, the appraisal may be higher or lower than the first estimate. The user may decide to rely on either of the estimates as desired.

If the user desires a second appraisal/estimate, the user submits the vehicle for bidding at step 608. At step 608, the dealer can push the completed vehicle condition and rating information into a cloud data environment of shared users where potentially interested buyers of that vehicle can be notified, enabling such users to rapidly respond to the sender with a bid to purchase that vehicle, thus crowd sourcing bid responses that can be used by the sender to determine a final valuation of the vehicle for sale or trade. This entire process can be activated in the system by selecting the “Get Appraisals” button 302 on the interface of FIG. 3, or any such final button as determined in the system.

The bidding may lead to a potential pending sale of the vehicle, either by the vehicle owner or by a dealer receiving the vehicle as a trade-in. In this manner, the dealer can be certain of disposing of the vehicle with a high degree of certainty, and need not wait for an upcoming auction to sell the vehicle. Further, this approach can obviate the need to hold the vehicle and sell it from the dealer's used car inventory, and expensive and time consuming approach.

Dealership users are also provided access on the Internet to a web-based dashboard available in the system where all user-completed vehicle appraisals are synchronized real time as they occur from the user's mobile device. The system dashboard also includes a data feed from the dealership's own vehicle inventory, allowing the user to maintain a daily view of all historical appraisals as well as those that have been added to inventory.

Bidding System

The system takes advantage of a network of dealers that participate in the system. A dynamic and fluid inventory of vehicles is available to the system as customers at dealerships propose a trade in of their vehicle as part of a car purchase. (Note that the system is not limited to trade in vehicles, but may be used for any vehicle encountered by a user of the system). Some dealers specialize in certain vehicles, such as European vehicles, trucks or sedans, or even specific makes of vehicles (e.g. Fords, Mercedes, and the like) and may be looking for vehicles in that category for their customers or their own inventory for sale. In other instances, a dealer may have a request from a customer for a particular vehicle and may seek it out using the system.

A dealer in the network will create an Agent in the system that identifies vehicles of interest to that dealer. The Agent may have an expiration date associated with it or it may be open ended. The Agent may have information such as year, make, model, color, options, and grade as metrics defining the desired vehicle or vehicles. The dealer can also establish a geographical zone of interest where the dealer considers only vehicles within the zone. In one embodiment, the Agent may include a range of prices based on certain metrics, such as color, year, grade, options, and the like, so that an automatic appraisal of the vehicle can be provided.

Crowd Sourced Bidding for Final Valuation and Appraisal

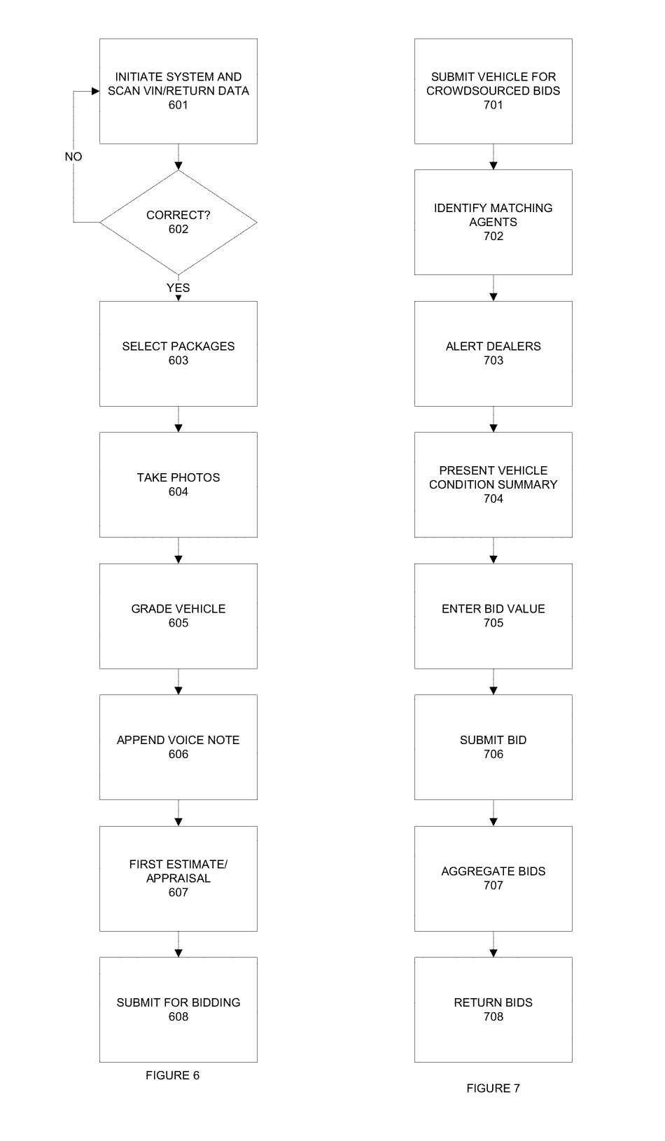

FIG. 7 is a flow diagram illustrating the operation of crowdsourced appraisal in an embodiment of the system triggered by step 608 of FIG. 6. When a dealer has completed the grading process on a vehicle, the dealer can then submit the vehicle to the cloud network of dealers at step 701 for a crowdsourced bidding for final valuation and appraisal. The system allows this to be done at any time after the appraisal process takes place. The dealer may submit the vehicle for live bidding during the negotiation process of trade-in value of the vehicle by the vehicle owner, before the dealer has completed the trade-in of the vehicle. This step of the process allows the system to expose the vehicle as available pre-trade to potentially interested purchasers (e.g. wholesalers) in real-time to avoid the 3-7 day wait that could occur before the vehicle shows up in inventory. The bids are non-binding in one embodiment, but allow both real world information for the user, as well as allowing a potential buyer to lock up a “first-in-line” status to potentially acquire the vehicle from a seller.

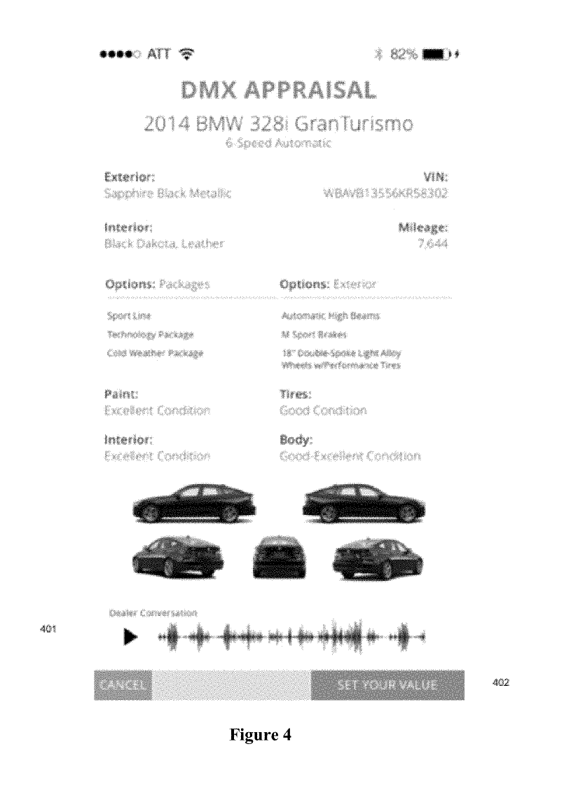

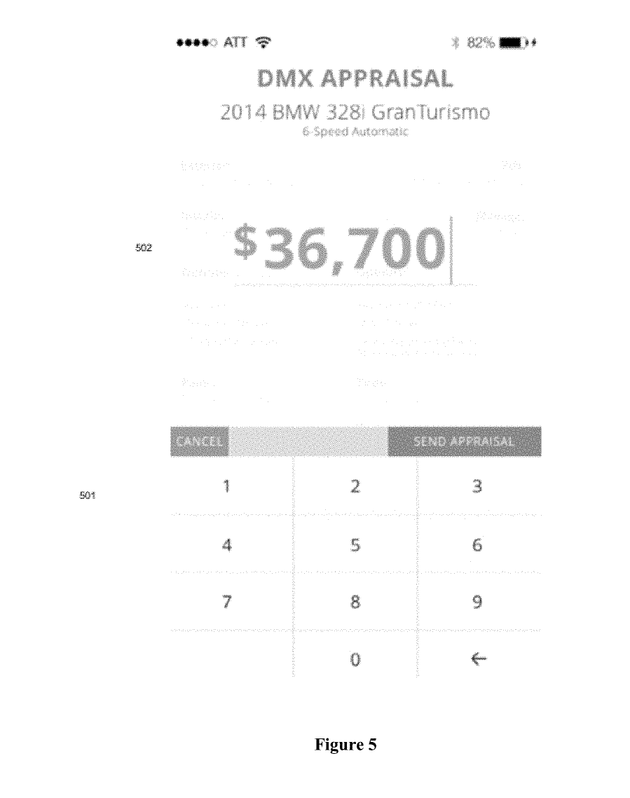

When the dealer submits the vehicle, the system identifies all other network dealers whose Agent matches the metrics of the vehicle at step 702. At step 703 all network dealers whose Agents match the vehicle profile are alerted that a new vehicle is available. At step 704 each network dealer is presented with the condition summary such as shown in FIG. 3. This information may or may not include the estimate values of region 304. The information may also include any audio notes associated with the vehicle as shown in FIG. 4. At step 705, the network dealer is then presented with a numeric touch screen as shown in FIG. 5 where the network dealer can enter a non-binding “bid” that they would assign to potentially (and separately) acquire the vehicle. This non-binding bid value reflects the price the network dealer would potentially pay for the vehicle if offered.

The network dealer submits the bid at step 706 and the system aggregates all submitted bids at step 707 and returns them to the requesting dealer at step 708. The requesting dealer can then use that crowdsourced return of bids to establish a final valuation and appraisal for a trade in value offer to the customer. This process may take a matter of minutes so that the requesting dealer can determine a dynamic and accurate real time appraisal of the trade in vehicle so that the most appropriate offer can be made to the customer.

System Server

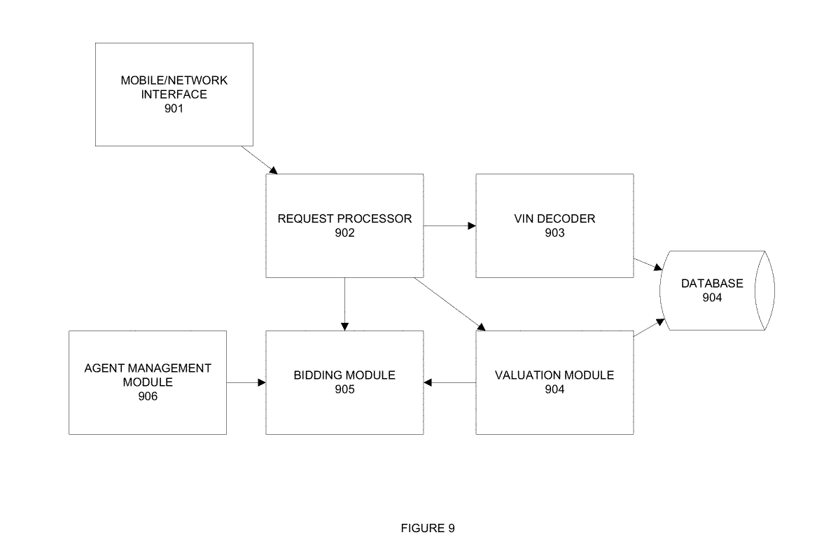

FIG. 9 is a block diagram of an exemplary system server 804 in one embodiment of the system. The system includes a mobile/network interface 901 for controlling communication with the mobile device 801, the Dealer Network 805, and 3^{rd} party services 807. A request processor receives calls, queries, and requests from the network and from the local modules and performs processes to respond to those requests. A VIN Decoder 903. The VIN decoder includes an API to interact with one or more 3^{rd} party services and to normalize the data received from the service for consistent use in the system. In some cases, VIN information may be present in database 904. The system contemplates maintaining a database of searched vehicles to increase the responsiveness of the system and to maintain a desired data format for use in the system.

A Valuation Module includes an API to communicate with one or more 3^{rd} party services related to valuation, such as KBB, BlackBook, Edmunds.com, and the like, to provide valuation information based on historical and other sources, based on the vehicle information as well as the user's physical location, by geo-fencing and locating the IP address of the device being used. These market book values are displayed in the application with corresponding company logos, for example. The Valuation Module 904 may also communicate with accident tracking services such as CarFax, insurance companies, and the like to provide vehicle history and repair information that may not be available from a visual inspection of the vehicle. These may also be displayed as complete reports, in part or in full, also with a corresponding company logo. The Valuation Model also includes a graphic representation, as well as a locational map (using Google Maps for example), placing the same valuation of that model vehicle across a designated distance perimeter, displaying where similar model vehicles are selling at a retail price and their currently listed values, as represented on the Internet. This provides the viewer a complete and composite view of what the current vehicle under review is valued for resale locally and regionally, trade value by assigned market book valuations, and as determined through unique algorithms in the application. This is strictly for the purpose of facilitating the user's ability in making an economic decision as to whether the vehicle could be taken as a trade, sold for retail, or sold for wholesale.

Bidding Module 905 is used to interface with the members of the Dealer Network that participate in the bidding for vehicles under consideration as described in FIG. 7. Agent Management Module 906 is used to store and manage Agents created by members of the Dealer Network 805.

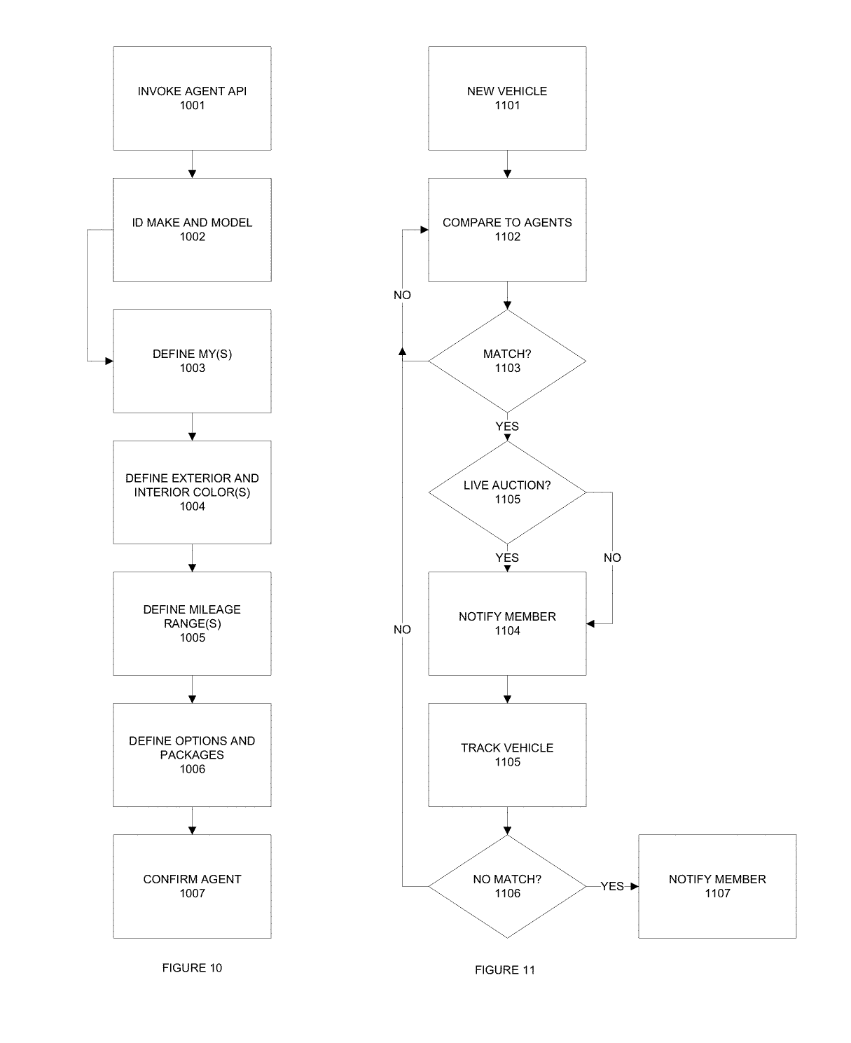

FIG. 10 is a flow diagram illustrating the generation of an Agent by a member using the Agent Management Module 906 in one embodiment. At step 1001 a member invokes the Agent API. This provides a dashboard on the members computing device (mobile phone, tablet, pad, laptop, desktop, and the like) so that the member can define the parameters of the Agent to search for the desired vehicle. At step 1002 the member defines the make and model of the desired vehicle. At step 1003 the member defines the year or years of the model of interest. The system allows the member to specify a single model year of vehicle or a range of model years as desired. It may be that a dealer, member, or customer is looking for a specific vehicle and is not as constrained by the model year. In other cases, the Agent is defined for a single model year of vehicle. At this point, the system retrieves data associated with the vehicle make and model for those model years, and restricts subsequent choices of the agent to those actually available on that vehicle type.

At step 1004 the member identifies exterior and interior colors of interest based on manufacturer and other third party information. The system also allows a NOT operation to restrict certain exterior and interior color combinations that are not desired, even though the individual colors may be on the Agent list.

At step 1005 the member can define the mileage limits of the vehicle. If multiple model years are defined, the system allows mileage ranges to be assigned to each separate model year. At step 1006, the system provides an interface of available options and packages for the selected vehicles and the member can select desired packages or specify any packages that are not desired. In other cases, the member can indicate “don't care” for some packages and options if no particular preference is expressed. At step 1007 the member confirms the agent and it is now part of the active system.

FIG. 11 is a flow diagram of the operation of the Agent Management Module 906. At step 1101 a new vehicle is entered into the system. At step 1102 the new vehicle is compared to agents in the system. At decision block 1103 it is determined if there is a match to one or more agents. If not, the system returns to step 1102 and continues to compare to agents in the system. If there is a match, the system then determines at decision block 1105 if the vehicle is part of a live auction or if it is simply available for sale. If it is part of a live auction, the member whose agent is matching is notified at step 1104 that it is a live auction. If it is not a live auction, the member is appropriately notified at step 1104.

At step 1105 the system continues to track the vehicle to determine if it is still available and if there are still agent matches. If the vehicle is not available, pursuant to decision block 1106, (such as by sale or other disposition), the system notifies each member that had a matching agent at step 1107. If the vehicle is still available at step 1106, the system returns to step 1102 to compare it to available agents. New agents can be created during the availability of the vehicle in the system, so the system continuously checks the agent population to determine if there is a match.

Trusted Appraisal/Grading

In one embodiment, the system includes a method for providing a trusted appraisal and grading of vehicles that can be relied on by the Dealer Network and 3^{rd} parties. In some cases, each valuation process obtains all the information required for a trusted appraisal. In other embodiments, the trusted appraisal is a different and more detailed inspection of the vehicle. For example, the trusted appraisal may be done by a dealer, mechanic, automobile inspector, or other auto professional after acquiring a vehicle. The trusted appraisal can use the mobile device to go through a checklist of questions, inspections, test drives, evaluations, images, and the like to generate a detailed appraisal and evaluation of the vehicle. When that is performed, the trusted appraisal can be associated with the VIN of the vehicle and stored in database 904 so that if the vehicle is searched subsequently, the trusted appraisal will be provided. The vehicle can be marked with a physical indicator of the inspection, or a trusted appraisal indicator can be included with any digital representation of the vehicle, so that interested parties may retrieve the trusted appraisal data and use it in making decisions about the vehicle.

In one embodiment, the trusted appraisal information is updated periodically by requesting information about the vehicle, such as from insurance claims, CarFax reports, and the like. Depending on the information, the trusted appraisal may be withdrawn or modified as appropriate.

The data available to a consumer who accesses the trusted appraisal includes all images, video, audio notes, and data associated with the inspection and appraisal process.

Although the trusted appraisal can be used by consumers, it also has value in a dealer-to-dealer exchange. Consumers have the benefit of legal protection and risk minimization laws and rules. The same safeguards are not always available in a dealer to dealer transaction. The system can reduce the subjective analysis of a vehicle to a more objective and quantitative analysis. The system also defines a grade that can be used to provide a more reliable evaluation of the vehicle. In the current art, grading schemes of a vehicle are typically excellent, good, fair, and poor. There is little useful guidance in these grades and no meaningful way to compare two or more vehicles with the same grade. One vehicle might be a “high” good while another might be a “low” good.

The system solves this by defining a plurality of objective measures and metrics to yield a more meaningful grade of an inspected vehicle. One of the features of the grading system is the use of Importance Points to weight Inspection Points in a plurality of categories associated with the inspection and evaluation of the vehicle. Each vehicle is defined as having a plurality of Categories for inspection. Each Category is comprised of a plurality of Inspection Points. Each Inspection Point is assigned a grade based on the inspection. The grade can be a letter grade (e.g. A, B, C, F, and the like), a numerical grade (e.g. 1-4, 1-5, 1-10, and the like) or some other indicator of grade. In addition to the grade, each inspection point is assigned is assigned an Importance Point of 1, 2, or 3 in one embodiment, where the Importance Point represents the following:

1. Doesn't' affect operation, drive, or quality perception of the vehicle

2. Likely affect either the operation, drive or quality perception of the vehicle

3. Strong correlation to the condition of the Inspection Point to the operation, drive or quality perception of the vehicle.

Each make or model of vehicle may have custom Categories, Inspection Points, and Importance Points. This is because the importance if certain inspection points will vary from model to model. For example, a truck may have an Importance Point of 3 for towing capability, while a minivan might have an Importance Point of 1 for towing capability.

Consider a situation where a Category has 34 Inspection Points. In an example, 10 of the 34 Inspection Points have a “3” on the Importance Index, 10 have a “2”, and 14 have “3”. This yields a total number of Important Points of 64 (30 +20 +14). This is referred to as the Importance Value. Now the grades can be defined for this category to have meaning as follows. An A will have 99% of the Importance Index Value assigned to each inspection point. A B grade will have 66.66% of the index value, a C will have 33.33% of the value and an F will have 0%.

For purposes of example, assume that half of the Inspection Points in each level of Importance Points (1,2, 3) received an A and half received a B. Using the number of Importance Points and the value of each grade yields the following:

15 Importance points @ A (e.g. 99%) results in 14.99

15 Importance Points @ B (e.g. 66.66%) results in 9.99

Continuing for the remaining 24 inspection points results in 53.33. With a total of 64 Importance Points available for that Category, the result of the inspection is 53.33/64=83%.

By using the Importance Points, Categories, and Inspection Points, and by customizing it for each vehicle, the system results in a meaningful percentage grade that provides real differences between vehicles that would otherwise be graded the same in the current art. In addition, the system allows the inspector to still rely on a simple A,B, C grading system for each individual Inspection Point, while yielding a more accurate grade for the vehicle at the end of the process.

Example Computer System

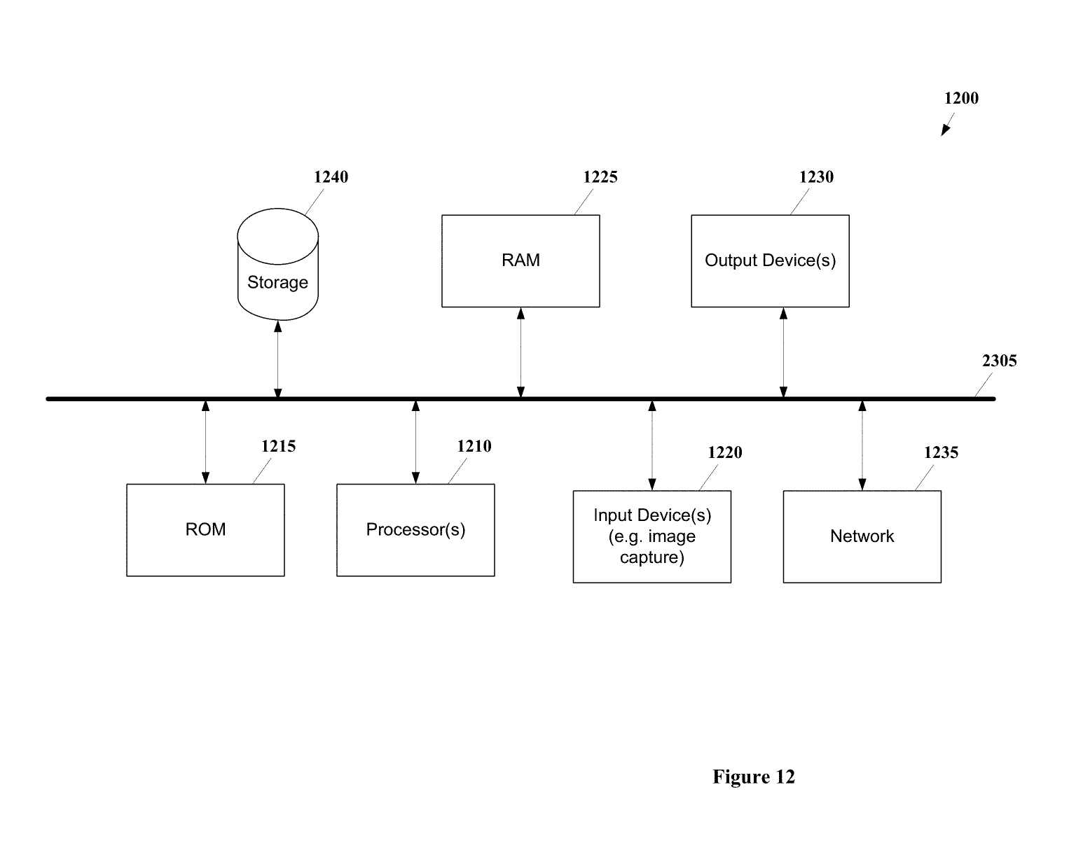

FIG. 12 illustrates an exemplary a system 1200 that may implement the system. The electronic system 1200 of some embodiments may be a mobile apparatus. The electronic system includes various types of machine readable media and interfaces. The electronic system includes a bus 1205, processor(s) 1210, read only memory (ROM) 1215, input device(s) 1220, random access memory (RAM) 1225, output device(s) 1230, a network component 1235, and a permanent storage device 1240.

The bus 1205 communicatively connects the internal devices and/or components of the electronic system. For instance, the bus 1205 communicatively connects the processor(s) 1210 with the ROM 1215, the RAM 1225, and the permanent storage 1240. The processor(s) 1210 retrieve instructions from the memory units to execute processes of the invention.

The processor(s) 1210 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 1210, they cause the processor(s) 1210 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 1210. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a web site, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 1200, define one or more specific machine implementations that execute and perform the operations of the software programs.

The ROM 1215 stores static instructions needed by the processor(s) 1210 and other components of the electronic system. The ROM may store the instructions necessary for the processor(s) 1210 to execute the processes provided by the system. The permanent storage 1240 is a non-volatile memory that stores instructions and data when the electronic system 1200 is on or off. The permanent storage 1240 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 1225 is a volatile read/write memory. The RAM 1225 stores instructions needed by the processor(s) 1210 at runtime, the RAM 1225 may also store the real-time video or still images acquired by the system. The bus 1205 also connects input and output devices 1220 and 1230. The input devices enable the user to communicate information and select commands to the electronic system. The input devices 1220 may be a keypad, image capture apparatus, or a touch screen display capable of receiving touch interactions. The output device(s) 1230 display images generated by the electronic system. The output devices may include printers or display devices such as monitors.

The bus 1205 also couples the electronic system to a network 1235. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method of appraising a vehicle comprising:
using a mobile device to;
obtain an image of the vehicle identification number (VIN) of the vehicle;
transmitting the VIN to a system server;
receiving, from the system server, system information about the vehicle based on the VIN;
confirming vehicle information based on the system information;
rating the vehicle condition using the mobile device to create a vehicle record;
transmitting the vehicle record to the system server;
receiving a first vehicle appraisal value from the system server;
transmitting the vehicle record to a plurality of users;
receiving one or more bids from the plurality of users to generate a second appraisal value.

2. The method of claim 1 wherein confirming the vehicle information is based on prompts from the mobile device to inspect one or more aspects of the vehicle.

3. The method of claim 1 wherein rating the vehicle condition is based on prompts from the mobile device to assign a rating to one or more aspects of the vehicle.

4. The method of claim 1 further including obtaining images of the vehicle in response to prompts from the mobile device.

5. The method of claim 1 wherein the first vehicle appraisal value is based on information from vehicle valuation services.

6. The method of claim 1 wherein the bids comprise non-binding bids from one or more users that have expressed an interest in one or more vehicles similar to the vehicle.

7. The method of claim 6 wherein the one or more users each define an Agent, wherein an Agent is a software description of a vehicle of interest.

8. The method of claim 7 wherein the system server compares the vehicle to a plurality of Agents and sends vehicle information to users who have defined an Agent matching the vehicle.

9. The method of claim 1 further including performing a detailed inspection of the vehicle based prompts from the mobile device.

10. The method of claim 9 wherein the inspection comprises a plurality of Categories, wherein each Category comprises a plurality of Inspection Points, and wherein each Inspection point is assigned an Importance Point.
